(19) United States
(12) Patent Application Publication
(10) Pub. No.: US 2006/0113090 A1
(43) Pub. Date: Jun. 1, 2006

(54) Hoof support stand

(76) Inventors: Charles Rinaldo DeCola, Grover Beach, CA (US); Derrek Hee, Nipomo, CA (US)

Correspondence Address: CHARLES R. DECOLA, P.O. BOX 570, GROVER BEACH, CA, 93483, US

(21) Appl. No.: 10/998,274

(22) Filed: Nov. 26, 2004

(51) Int. Cl. A01L 7/00

(52) U.S. Cl. 168/44

(57) ABSTRACT

A hoof stand is disclosed which includes a flattened tripod base and a generally vertical support which may be quickly changed from pillar to cradle, allowing a horse's hoof to be held as desired in the normal or inverted positions, as an aid in horseshoeing and hoof maintenance. Continuous height adjustment is provided by telescoping receiving members, which may be quickly clamped together and quickly released. Collapsibility is provided by removing a tubular segment or by retractable legs. A pad on the cradle and texture on the pillar provide increased functionality and safety.

### BACKGROUND

1. Field of the Invention

Traditionally, farriers, veterinarians, and horse owners, pick-up and hold a hoof using only their hands and legs to position the hoof for horseshoeing, and hoof care. The invention herein relates to a tool to assist in the positioning of a horse's hoof for shoeing and maintenance.

2. Overview of Prior Art

Keeler (U.S. Pat. No. 6,325,154 and U.S. Pat. No. 6,640,905) discloses a farrier's stand that uses a sling to receive and support an inverted hoof, and a second un-attached upright member to receive the distal portion of a hoof. In order to change from the sling to upright member the user must loosen a thumbscrew and remove one unit, and locate, position and insert another support that then must be tightened in place. This must be done at least once per hoof.

An additional frustration associated with Keeler's embodiment is the large flat base, which may be unstable on anything other than flat ground.

U.S. Pat. No. 4,167,216 teaches the desirability of being able to quickly change from a cradle (concave support) to a flat top pillar. It, however, does not offer height adjustment, requires repositioning when changing from cradle to pillar, and is somewhat unstable due to the positioning of the vertical column with respect to the three legs.

### SUMMARY OF THE INVENTION

The disclosed invention relates to a device that is adapted to receiving and holding a horse's hoof as required, in both the upright or inverted positions as desired, to aid in horseshoeing and hoof maintenance. In the preferred embodiment the device includes a flattened tripod base. A vertical receiving portion is tubular with a clamping device allowing positioning of a head portion with respect to distance above the ground. The head portion has a first end and second end. The first end has a substantially cylindrical first rod extending therefrom. This first rod is suited for being received by the base and held in position thereby. The second end is capped with a short cylinder of greater diameter than the rod, whereupon texture has been incorporated into the upper planar surface as an aid in positioning the hoof. Intermediate to the first and second ends of the rod is a hinge, or pivot point consisting of a second smaller rod attached perpendicular to the first rod, supporting arms connect a padded concave section, the cradle. The horse's hoof may be held in a position inverted to the normal position when walking, by positioning it in the cradle. A latch is incorporated to hold the cradle in the in-use position, and release it to a stowed position as needed, exposing the textured cylindrical pillar for use. The cradle may be pivoted back into the in-use position in a few seconds as needed. The vertical receiving portion telescopes into a larger generally vertical receiving portion that grips for use or releases for storage as required.

### BRIEF DESCRIPTION OF THE DRAWINGS

FIG. 1 is a perspective view of the hoof support stand, produced in accordance with the preferred embodiment of the present invention.

FIG. 2 hoof support stand, with the cradle pivoted down to the stowed position. The pillar is shown in the in-use position.

FIG. 3 a top view of the stand, cradle up.

FIG. 4 a top view, cradle down. The textured pillar is exposed.

FIG. 5 a side view, legs folded into the stowed position.

FIG. 6 a bottom view, legs stowed.

### DETAILED DESCRIPTION OF THE PREFERED EMBODIMENTS

FIG. 1. The preferred embodiment of the hoof support stand 10 with cradle deployed. The tool consists of a support, with legs 11, capped 12. Receiving member 18 is telescoped into receiving member 40 held in a generally vertical position by legs 11. A post 16 is inserted into receiving member 18 and may be positioned for height adjustment and tightened in place by a clamp 14. At the other end of post 16, a pillar 30 is provided to support an animal's hoof in the normal orientation. A cradle 38 is provided to support hoofs in an inverted position. A means of stowing the cradle 38 is provided: the cradle is attached to shaft 16 by arms 28 that pivot on shaft 20. The cradle is held in the deployed position by a spring-loaded latch 36 that engages tab 42 on the shaft 16. Spring 24 is attached at one end to an extension 26 of latch 36 and at the other end to an extension 22 of arm 28. The latch 36 pivots on post 44. Fastener 46 secures tube 18 when in use.

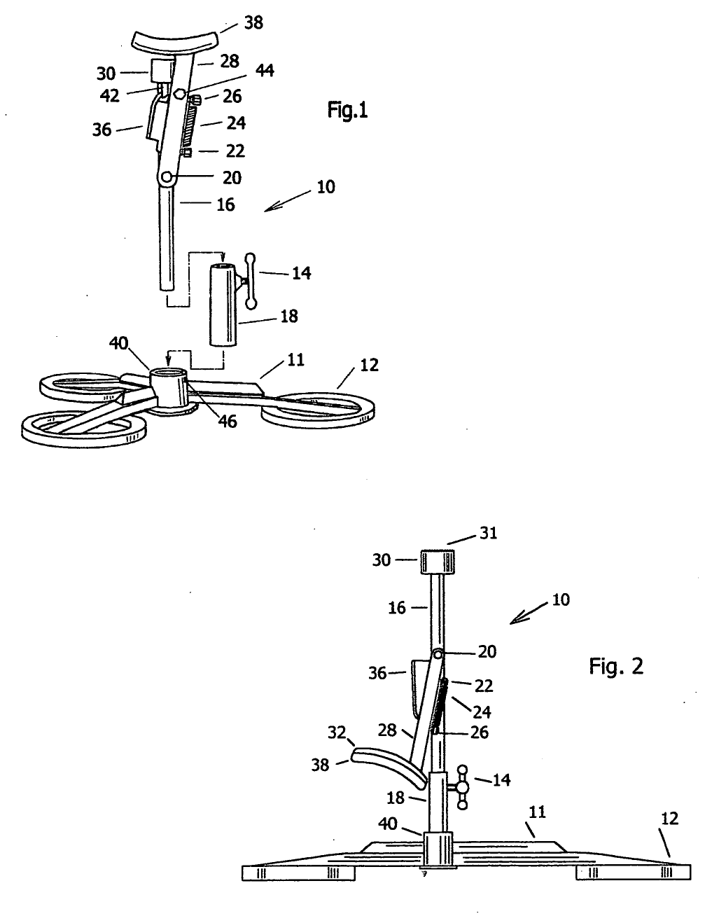

FIG. 2. A rear elevation of the preferred embodiment 10. Latch 36 has been depressed, thereby releasing cradle 32 with pad 38, readying the pillar 30, with textured end 31 for work. Arms 28 connect and pivot the cradle assembly to shaft 16 via shaft 20. The cradle assembly is ready to be swung back and latched in position above pillar 30 as shown in FIG. 1. Removable receiving member 18 is shown telescoped into receiving member 40.

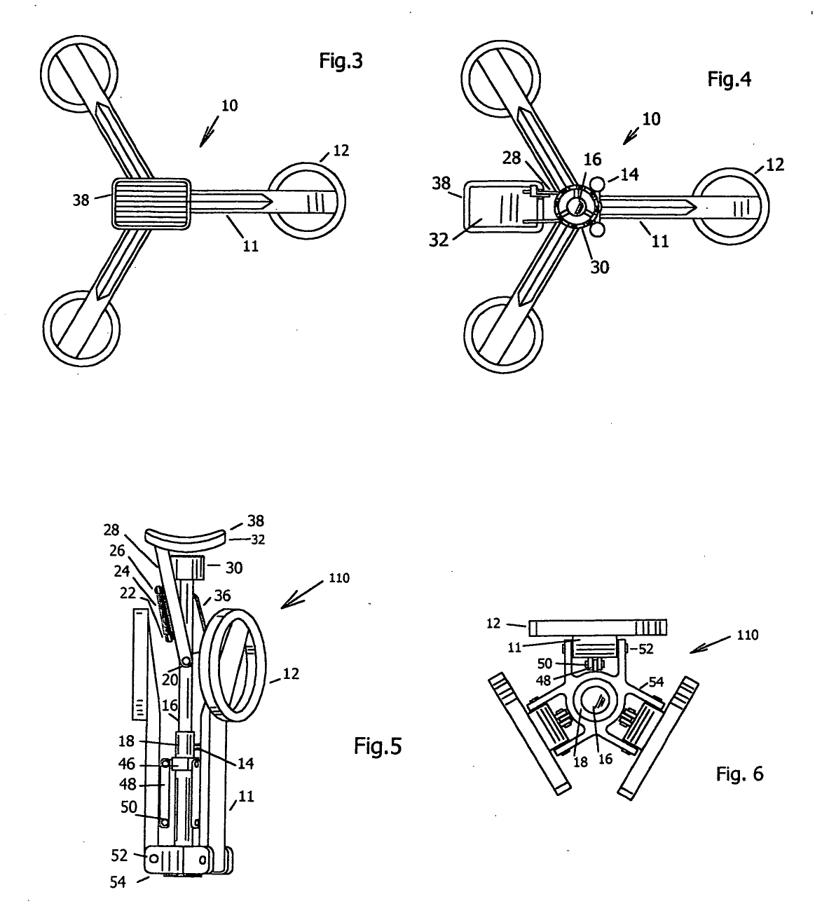

FIG. 3. Top view of stand 10, cradle pad 38 up. Legs 11 with caps 12 are shown.

FIG. 4. Top view of stand 10, cradle 36 and pad 38 down, supported by arms 28. Pillar 30, is uncovered and readied for work.

FIG. 5. An elevation view of stand 110 with legs 11 and caps 12 retracted for storage. Collar 46 slides and locks in place along tubular member 18, moving braces 48 from stowed, to in-use, and back. Shafts 50 provide attachment and pivot points to brace 48. Shaft 52 provides attachment and pivot points to legs 11 to forked collar 54.

FIG. 6. A bottom view of stand 110, legs 11 and caps 12 retracted. The forked collar 54, movable braces 48, and pivot shafts 50 are shown.

What is claimed is:

1. A horseshoeing and horse care device comprising:
a base: supporting fixture with a generally upright receiving portion;
a substantially longitudinal head with a first end and a second end, where the first end is a post capable of being held in a generally vertical position by the receiving portion of the base;
a second end of the head, capped by a short generally cylindrical post larger than the first post;
intermediate to the first and second ends of the post, a hinge, or pivot point consisting of a second smaller post attached generally perpendicularly to the first post;
a substantially concave longitudinal body attached to the smaller post or hinge, movable from deployed to stowed positions, and back as required.

2. A device as described in claim 1,
further comprising a latching and un-latching mechanism for positioning and de-positioning said substantially concave longitudinal body with respect to said support.

3. A device as described in claim 1, wherein said support may be received by a central tubular section with general verticality, of a shallow tripod providing a generally flat base which may itself receive the weight of the operator who may place one or more of his feet on the legs of said tripod.

4. A device as described in claim 3, where the base has a plurality of legs.

5. A device as described in claim 4 where the legs fold or pivotally retract for storage.

6. A device as described in claim 3, wherein said support may be positioned and secured in the base at varying heights, by a hand-operated threaded shaft that presses against the post portion of the head, or a cam lock system.

7. A device as in claim 1 where the substantially concave longitudinal body is padded.

8. A device as in claim 1 where the short generally cylindrical rod or tube is textured on the upper planar surface.

9. A device as in claim 1 where the generally upright receiving base. portion may be releasably secured in the receiving portion of the base.

10. A device as in claim 1 where posts are rods or hollow tubes.

11. A device as in claim 1 constructed from metal or plastic.
